(19) United States
(12) Patent Application Publication
(10) Pub. No.: US 2006/0033327 A1
(43) Pub. Date: Feb. 16, 2006

(54) Hose clamp end guard

(76) Inventor: Gaetan Verstraeten, Beverly Hills, CA (US)

Correspondence Address: Finn T. Simmensen;KLEINBERG & LERNER, LLP, Suite 1080, 2049 Century Park East, Los Angeles, CA, 90067, US

(21) Appl. No.: 10/918,042

(22) Filed: Aug. 13, 2004

(51) Int. Cl. F16L 55/00

(52) U.S. Cl. 285/45

(57) ABSTRACT

A hose clamp end guard has an elastic shell with a beveled opening to allow the shell to be pressed onto an end of a hose clamp band. The shell has flat surfaces which may be textured for gripping. The shell has one or more sets of opposing surfaces, including, for example, concave contoured surfaces, which are shaped to make it easier for a person to grip the shell and push the shell onto the hose clamp band end or pull it off of the hose clamp band end, even in a tight space or where the person's fingers are cold, numb, or greasy or the person is wearing gloves. The shell has a concave contoured front to reduce interference with hose clamp structures such as a screw or nut when the excess length of the band is short. The shell is formed of an elastomer, preferably a thermoplastic elastomer, and is soft enough to be trimmed with scissors if needed as, for example, when the excess length of the band is very short.

### BACKGROUND OF THE INVENTION

1. Field of the Invention

The present invention relates to protective covers, particularly to such covers on hose clamps, and especially to removable elastic covers.

2. Description of the Related Art

A person servicing an engine or other machinery (for example, a marine engine) may be injured or inconvenienced by a sharp edge of an end of a hose clamp protruding into the confined space of the engine or machinery compartment. The same can be said of household environments where, for example, a person may be making repairs in a garden or basement or under a sink. At least one supplier makes it possible to ameliorate this problem by offering hose clamp whose end is covered with a cap which is either molded or mechanically attached. See U.S. Pat. No. 5,647,614, assigned to Toyox Co Ltd., Toyama-ken, Japan.

Another supplier, Perko, Inc., 16490 NW 13^{th} Avenue, Miami, Fla. 33169-5707, telephone (305) 621-7525, website http://www.perko.com/ sells a r window stop comprising a rubber sleeve. The inventor hereof perceived a need for a hose clamp end guard better suited for a variety of uses in the household, in swimming pool and spa equipment, around air conditioning equipment, and in machinery spaces and engine compartments, including marine engine compartments. In particular, the inventor hereof perceived a need for an end guard improved to provide both safety and convenience under a variety of conditions.

### SUMMARY OF THE INVENTION

It is an object of the present invention to provide an inexpensive, easily applied hose clamp end guard providing increased safety and convenience for general use and for use particularly in machinery spaces and engine compartments, notably including marine engine compartments.

In accordance with this object and with others which will be described and which will become apparent, an exemplary embodiment of the hose clamp end guard in accordance with the present invention comprises a shell; an opening defined in the shell for receiving an end of a band; at least one gripping surface defined within the shell for gripping the end of the band; and at least one concave contoured outer surface formed on the shell. The shell may be elastic in order to better grip the end of the band.

In another exemplary embodiment of the hose clamp end guard in accordance with the present invention, the shell defines opposing concave contoured surfaces.

In another exemplary embodiment, the shell defines at least one textured surface.

In another exemplary embodiment, the shell defines opposing textured surfaces.

In another exemplary embodiment, the concave contoured outer surface is concave lengthwise and flat from top to bottom.

In another exemplary embodiment, the shell defines opposing outer surfaces at least one of which is concave in at least one dimension.

Another exemplary embodiment of the hose clamp end guard includes a shell; an opening formed in an end of the shell; an interior space, defined lengthwise within the shell, communicating with the opening; and mutually opposed outer surfaces defined on the shell laterally of the interior space, at least one of the mutually opposed outer surfaces being concave lengthwise.

Another exemplary embodiment of the hose clamp end guard includes a shell; an opening formed in an end of the shell; an interior space, defined lengthwise within the shell, communicating with the opening; and mutually opposed outer surfaces defined on the shell laterally of the interior space, at least one of the mutually opposed outer surfaces being flat in cross section.

In another exemplary embodiment of the hose clamp end guard, the shell is formed of a material soft enough to be cut by scissors or by a knife. The material may have a hardness of approximately 70 shore.

In another exemplary embodiment, the front of the shell is formed with a concave contour.

In another exemplary embodiment, a gripping surface comprises at least one bevel.

In another exemplary embodiment, a gripping surface comprises a plurality of bevels, facilitating insertion of a band into the shell.

In another exemplary embodiment, the shell defines at least one beveled surface near the opening, facilitating insertion of a band into the shell, facilitating insertion of a band into the shell.

### BRIEF DESCRIPTION OF THE DRAWING

For a further understanding of the objects and advantages of the present invention, reference should be had to the following detailed description, taken in conjunction with the accompanying drawing, in which like parts are given like reference numbers and wherein:

FIG. 1 is a perspective view of a hose clamp end guard in accordance with the present invention;

FIG. 2 is a perspective view thereof proximate a hose clamp;

FIG. 3 is a perspective view thereof installed on a hose clamp;

FIG. 4 is a front sectional view taken along section line 4-4 in FIG. 3;

FIG. 5 is a side sectional view thereof taken along line 5-5 in FIG. 3;

FIG. 6 is a top sectional view thereof taken along line 6-6 of FIG. 5; and

FIG. 7 is a perspective view of the hose clamp end guard mounted on a spring clamp.

### DESCRIPTION OF THE PREFERRED EMBODIMENTS

The invention will now be described with reference to FIG. 1, which illustrates in perspective view a preferred embodiment of hose clamp end guard in accordance with the present invention, shown generally by the reference number 20, including a shell 30, a closed back 32; top and bottom flat surfaces 34, concave contoured surfaces 36, a concave contoured front 38, and an opening 40.

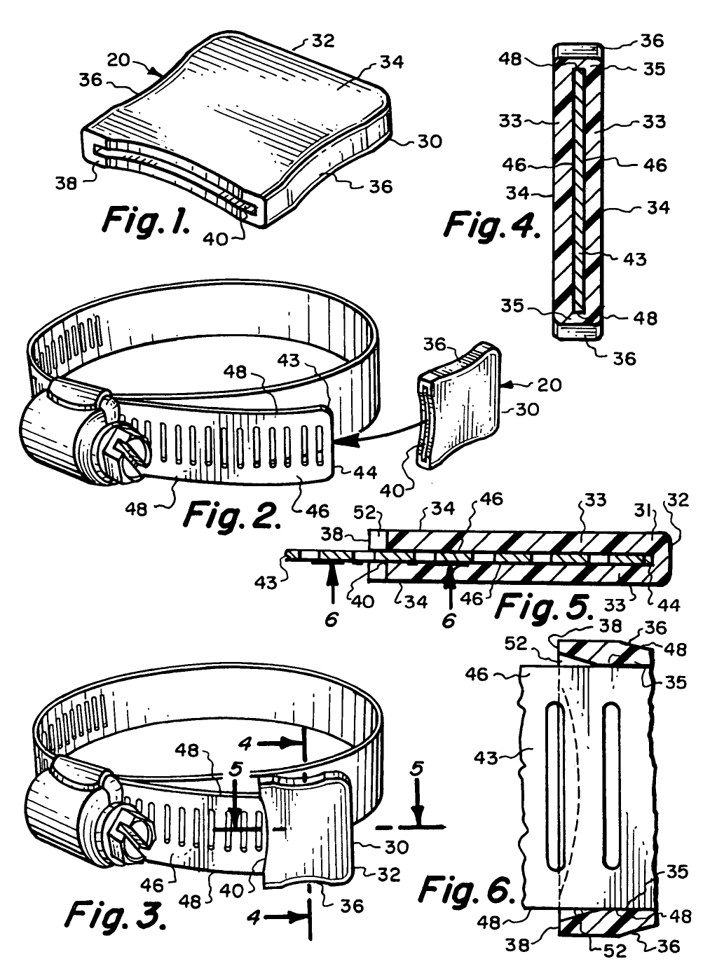

FIG. 2, another perspective view of the embodiment of FIG. 1, shows the shell 30 with the opening 40 proximate a hose clamp band 43 defining an end 44, opposing broad surfaces 46 and opposing edges 48.

FIG. 3, another perspective view of the embodiment of FIG. 1, shows hose clamp end 44 inserted into the opening 40 of the shell 30.

FIG. 4, a front sectional view taken along section line 4-4 in FIG. 3, shows top and bottom grasping portions 33 forming the flat surfaces 34; left and right grasping portions 35 forming the left and right contoured surfaces 36; the hose clamp band 43; the broad surfaces 46 disposed against the top and bottom grasping portions 33; and the edges 48 disposed against the left and right grasping portions 35.

FIG. 5, a side sectional view taken along line 5-5 in FIG. 3, shows a back portion 31 forming the closed back 32; the top and bottom grasping portions 33 forming the flat surfaces 34; the hose clamp 43 disposed through the opening 40; the end 44 approximated to the back portion 31; and the opposing broad surfaces 46 disposed against the top and bottom grasping portions 33.

FIG. 6, a top sectional view taken along line 6-6 in FIG. 5, shows left and right contoured surfaces 36; bevels 52 proximate the opening 40; the left and right grasping portions 35 disposed against the edges 48 of the hose clamp band 43; and a broad surface 46 of the hose clamp band.

With reference to FIGS. 1, 2, and 6, in a preferred embodiment of the hose clamp end guard 20 in accordance with the present invention, the shell 30 is formed of an elastic material such as a high-temperature polymer or, for example, 70A shore TPE (thermoplastic elastomer). In at least one preferred embodiment, the material should be soft enough to be cut with scissors if it becomes desirable to trim the shell 30 where the hose clamp end 44 is very short. The shell 30 and the opening 40 are provided in various sizes to fit different sized clamps. When the hose clamp end guard 20 is properly matched to the size of the hose clamp band 43, the distance across the opening 40 at the front 38 is approximately equal to the distance between the edges 48 of the hose clamp band 43 when the hose clamp end guard 20 is not yet mounted on the hose clamp band 43. As the end 44 of the hose clamp band 43 is advanced into the opening 40, the bevels 52 center the end 44 between the left and right grasping portions 35. As the end 44 advances toward the back portion 31, the edges 48 are squeezed between the left and right grasping portions 35, and the top and bottom grasping portions 33 of the shell 30 contact the broad surfaces 46 of the hose clamp band 43. As a result, the hose clamp end guard 20 will remain secured on the hose clamp band 43 until it is deliberately pulled off.

The hose clamp end guard in accordance with the present invention is conveniently adaptable to a variety of sizes of bands 43, including bands that are somewhat wider than the separation between the left and right grasping portions 35 of an uninstalled shell 30. The bevels 52 make it easier to start inserting a band 43 into the opening 40 of the shell 30. Once insertion is started, it is more easily completed.

With reference to FIGS. 1, 3, and 4, the concave contoured surfaces 36 of the shell 30 provide opposed, flattened, inward-curving surfaces facilitating a stable grip for pulling the hose clamp end guard 20 off of, and pushing it onto, the hose clamp band 43. Advantageously, these surfaces are separated by a distance slightly greater than the width of the hose clamp band 43 and are exposed laterally. A person's fingers may be too fat to get between the hose clamp end guard 20 and the underlying hose-encircling portion of the hose clamp band 43. Consequently, needle-nose pliers might be needed in order to grip the top and bottom flat surfaces 34. However, there is often enough clearance for fingers to approach laterally and grasp the concave contoured surfaces 36.

The concave contoured surfaces 36 are flat in one dimension even though they are curved in another. As a result, when the hose clamp end guard 20 is not mounted on the hose clamp band 43 and the concave contoured surfaces 36 are held manually, as between a person's thumb and forefinger, the person's grip is stabilized. If the concave contoured surfaces were convex from top to bottom, instead of flat as shown in the drawing, the person's grip would be less stable. In a crowded compartment, with poor lighting, or with cold, numb fingers and cramped hands, a person may be very thankful for this advantage.

With general reference to FIG. 1, in a preferred embodiment of the hose clamp end guard 20 in accordance with the present invention, the top and bottom flat surfaces 34 are rough in texture. Consequently, the top and bottom flat surfaces 34 may be grasped with at least moderate effectiveness even in the presence of grease or other slippery materials.

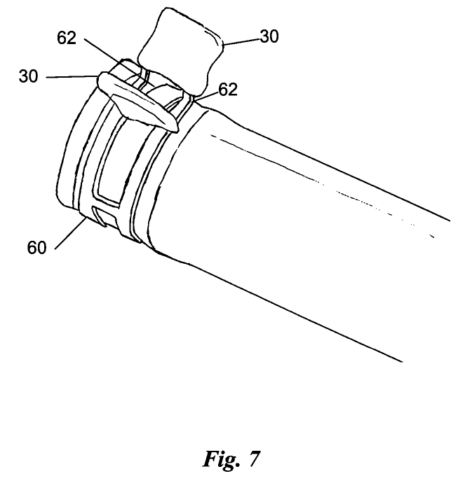

FIG. 7 shows an exemplary embodiment of the hose clamp end guard in which a shell 30 is pressed onto each of the two ends end 62 of a spring clamp 60. It will be appreciated that the ends 62 may be several millimeters in thickness. The shell 30, being formed of an elastomer, fits over the end 62.

In an alternative embodiment of a hose clamp end guard in accordance with the present invention, only one side is formed with a concave contour. The opposing side may, for example, be straight or convex (lengthwise) and flat or concave (top to bottom), so long as the side surfaces cooperate in at least some of the ways set forth herein to facilitate installation or removal of the hose clamp end guard from a hose clamp band.

In a preferred embodiment of a hose clamp end guard in accordance with the present invention, the concave contoured front 38 facilitates placing the shell on a relatively short end 44 of a hose clamp band 43. Particularly where the hose clamp comprises a screw for tightening the clamp and there is very little excess length of the hose clamp band 43, by the time the shell 30 is pushed far enough onto the band 43 to stay mounted, the screw or other parts of the clamp may already be interfering with the front 38 of the shell 30. To lessen this problem, the front 38 is concave contoured, thereby allowing the left and right grasping portions 35 of the shell 30 to slide farther onto the band 43 before the front 38 begins to interfere with other structure of the hose clamp.

In a preferred embodiment of a hose clamp end guard in accordance with the present invention, the shell 30 is formed of a material soft enough to be cut with scissors. This embodiment provides the convenience of trimming the shell 30 in situations where the excess length of the band 43 is so short that the full-length shell 30 would protrude or be unstable when mounted on the end 44. This versatility is an advantage, for it can be appreciated that trimming would be difficult or impossible if the shell were formed of a hard material, if it were equipped with projections specially matched to the threads or through-holes of a particular hose clamp band 43, or if it were permanently installed on the end 44.

The elasticity of the hose clamp end guard in accordance with the present invention makes it useful on a variety of clamp ends without special adaptation to the structural details of a clamp end. For example, a conventional end cap designed for a specific screw-tightened clamp may have an insertion hole and projections extending into the insertion hole, the projections being specially fitted to match the threads of the clamp band. The present invention has no need to be specially designed for such threads. Moreover, the hose clamp end guard in accordance with the present invention happens to fit two very popular, somewhat different sizes of clamp bands on the market. One of them happens to be marketed for automotive uses, the other, slightly wider, is marketed for marine uses. Being elastic, one size end guard in accordance with the present invention very conveniently fits both.

While the foregoing detailed description has described several embodiments of a hose clamp end guard in accordance with the present invention, it is to be understood that the above description is illustrative only and not limiting of the disclosed invention. Indeed, it will be appreciated that the embodiments discussed above and the virtually infinite embodiments that are not mentioned could easily be within the scope and spirit of the present invention. Thus, the present invention is to be limited only by the claims as set forth below.

1. A hose clamp end guard, comprising:
a shell;
an opening defined in said shell for receiving an end of a band;
at least one gripping surface defined within said shell for gripping the end of the band; and
at least one concave contoured outer surface formed on said shell.

2. A hose clamp end guard as set forth in claim 1, wherein said shell is elastic.

3. A hose clamp end guard as set forth in claim 1, wherein said shell defines opposing concave contoured surfaces.

4. A hose clamp end guard as set forth in claim 1, wherein said shell defines at least one textured surface.

5. A hose clamp end guard as set forth in claim 1, wherein said shell defines opposing textured surfaces.

6. A hose clamp end guard as set forth in claim 1, wherein said concave contoured outer surface is concave lengthwise and flat from top to bottom.

7. A hose clamp end guard as set forth in claim 1, wherein said shell defines opposing outer surfaces at least one of which is concave in at least one dimension.

8. A hose clamp end guard for placement on a hose clamp band end proximate a hose surface, the hose clamp end guard comprising:
a shell;
an opening formed in an end of said shell;
an interior space, defined lengthwise within said shell, communicating with said opening; and
mutually opposed outer surfaces defined on said shell laterally of said interior space,
at least one of said mutually opposed outer surfaces being concave lengthwise.

9. A hose clamp end guard for placement on a hose clamp band end proximate a hose surface, the hose clamp end guard comprising:
a shell;
an opening formed in an end of said shell;
an interior space, defined lengthwise within said shell, communicating with said opening; and
mutually opposed outer surfaces defined on said shell laterally of said interior space,
at least one of said mutually opposed outer surfaces being flat in cross section.

10. A hose clamp end guard as set forth in claim 1, wherein said shell is formed of a material soft enough to be cut by scissors.

11. A hose clamp end guard as set forth in claim 1, wherein said shell is formed of a material soft enough to be cut by a knife.

12. A hose clamp end guard as set forth in claim 1, wherein said shell is formed of a material having a hardness of approximately 70 shore.

13. A hose clamp end guard as set forth in claim 1, wherein said shell forms a concave curved front surrounding said opening.

14. A hose clamp end guard as set forth in claim 1, wherein said shell is formed of an elastomer.

15. A hose clamp end guard as set forth in claim 1, wherein said shell is formed of a thermoplastic elastomer.

16. A hose clamp end guard as set forth in claim 1, wherein said at least one gripping surface comprises at least one bevel.

17. A hose clamp end guard as set forth in claim 1, wherein said at least one gripping surface comprises a plurality of bevels.

18. A hose clamp end guard as set forth in claim 1, wherein said shell defines at least one beveled surface proximate said opening.

19. A clamp, comprising:
a band for encircling an object, said clamp comprising an end;
a shell disposed on said end;
said shell having a front defining an opening;
said shell defining an interior space lengthwise within said shell, said interior space communicating with said opening and receiving said end of said clamp;
said shell forming at least one pair of mutually opposed outer surfaces laterally of said interior space,
at least one of said outer surfaces being concave contoured.

20. A clamp as set forth in claim 19, wherein said shell defines opposing outer surfaces at least one of which is concave in at least one dimension.

21. A clamp as set forth in claim 19, wherein said concave contoured outer surface is concave lengthwise and flat from top to bottom.

22. A clamp as set forth in claim 19, wherein said front of said shell forms a concave surface proximate said opening.

23. A clamp as set forth in claim 19, wherein said shell defines at least one beveled surface proximate said opening.

24. A clamp as set forth in claim 19, wherein said shell defines at least one textured surface.

25. A clamp as set forth in claim 19, wherein said shell is formed of an elastomer.

26. A clamp as set forth in claim 19, wherein said shell is formed of a material having a hardness of approximately 70 shore.

27. A clamp as set forth in claim 20, wherein said shell forms a concave surface proximate said opening and at least one beveled surface proximate said opening.

28. A clamp as set forth in claim 21, wherein said shell is formed of an elastomer and forms at least one textured surface.
